(19) United States
(12) Patent Application Publication
(10) Pub. No.: US 2006/0291853 A1
(43) Pub. Date: Dec. 28, 2006

(54) Electronic device and image capture module thereof

(75) Inventors: Yi-Ming Lee, Taipei (TW); Yen-Kuang Chen, Taipei (TW); Yung Chuan Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/452,266

(22) Filed: Jun. 14, 2006

(30) Foreign Application Priority Data
Jun. 24, 2005 (TW) 094121299
Jun. 28, 2005 (CN) 200510080267.7

(51) Int. Cl. G03B 17/00

(52) U.S. Cl. 396/529

(57) ABSTRACT

An image capture module includes a housing, a camera unit, and a shielding element. In this case, the housing has a first opening. The camera unit is accommodated in the housing and is adjacent to the first opening. The first opening exposes at lest one portion of the camera unit. The shielding element is disposed between the camera unit and the housing. The shielding element is disposed around the camera unit such that the shielding element and the camera unit cover the first opening.

### BACKGROUND OF THE INVENTION

1. Field of Invention

The invention relates to an electronic device and an image capture module thereof and, in particular, to an electronic device and an image capture module thereof that are designed for preventing particles pollution.

2. Related Art

With great progress in the technology, photograph function is not only carried out in digital cameras and video recorders but also in portable communication devices extensively. Nowadays, the portable communication devices with the photograph function are a main tendency in the market.

The conventional portable communication device having photograph function utilizes an image capture module to capture an image of object. Then, image information is recorded on a recording medium. With reference to FIG. 1, the conventional image capture module 1 includes a housing 10, a camera unit 11, and a sensor 12. The housing 10 is formed with a front cover 101 and a rear cover 102. In this case, the front cover 101 has an opening 101A. The camera unit 11 including a barrel 111 and a lens assembly 112 is accommodated in the housing 10. The barrel 111 includes a container 1111 where the lens assembly 112 is accommodated. Therefore, the opening 101A of the front cover 101 exposes a portion of the camera unit 11. The sensor 12 is disposed between the camera unit 11 and housing 10 to receive a light beam passing the camera unit 11. Herein, the sensor 12 can be a charge coupled device (CCD) or a complementary metal oxide semiconductor sensor (CMOS).

The conventional image capture module 1 generally includes a focus system (not shown in the figure) and, in particular, when the focus system is an auto-focus system, the focus system can improve quality of the image picked up. Furthermore, the focus system includes a transmission element, which can drive the camera unit 11 close to or away from the opening 101A to reach an optimum position for focusing in accordance with the distance of the object placed.

As mentioned above, appropriate space 13 between the opening 101A of the housing 10 and the camera unit 11 is required to allow the camera unit 11 moving forwards and backwards, so that the camera unit 11 can smoothly move corresponding to the opening 101A. However, the aforesaid space 13 may let the foreign tiny particles easily enter the image capture module 1 to affect the quality of the image picked up.

Therefore, according to the above-mentioned problems of the state of the art, it is a subjective to provide an electronic device and an image capture module thereof that are designed for blocking particles to enter themselves

### SUMMARY OF THE INVENTION

In view of the foregoing, the invention is to provide an electronic device and an image capture module thereof that are designed for blocking particles to enter themselves and having a shock absorbing ability.

To achieve the above, an image capture module of the invention includes a housing, a camera unit, and a shielding element. In this case, the housing has a first opening. The camera unit is accommodated in the housing and is adjacent to the first opening. The first opening exposes at lest one portion of the camera unit. The shielding element is disposed between the camera unit and the housing. The shielding element is disposed around the camera unit such that the shielding element and the camera unit cover the first opening.

To achieve the above, an electronic device of the invention includes an image capture module and a main body. In this case, the image capture module includes a housing, a camera unit, and a shielding element. The housing has a first opening. The camera unit is accommodated in the housing and is adjacent to the first opening. The first opening exposes at lest one portion of the camera unit. The shielding element is disposed between the camera unit and the housing. The shielding element is disposed around the camera unit such that the shielding element and the camera unit cover the first opening. The image capture module is accommodated in the main body. The main body has a second opening and a transparent cover. The second opening is correspondingly disposed with the first opening. The transparent cover covers the second opening.

As mentioned above, the electronic device and the image capture module thereof of the invention are by way of disposing a shielding element between the camera unit and the housing. Specially, the shielding element is disposed around the camera unit such that the shielding element and the camera unit covers the first opening of the housing. Due to no space between the housing and the camera unit, the foreign particles are prevented from entering into the image capture module. Moreover, the shielding element can be elastic for absorbing the shock generated in the movement of the camera unit corresponding to the first opening. Therefore, the image capture module of the invention further has an absorbing shock effect. In addition, the surface of the shielding element can be designed for having a rough structure, such as a waved structure or a ladder structure. The rough structure is used to absorb or reflect the useless light beams for image generation so as to improve the quality of the image. Furthermore, the shielding element can be doped with mental particles to reduce interference of the electromagnetic wave.

### BRIEF DESCRIPTION OF THE DRAWINGS

The invention will become more fully understood from the detailed description given herein below illustration only, and thus is not limitative of the present invention, and wherein:

FIG. 1 is a schematic sectional view showing the conventional image capture module;

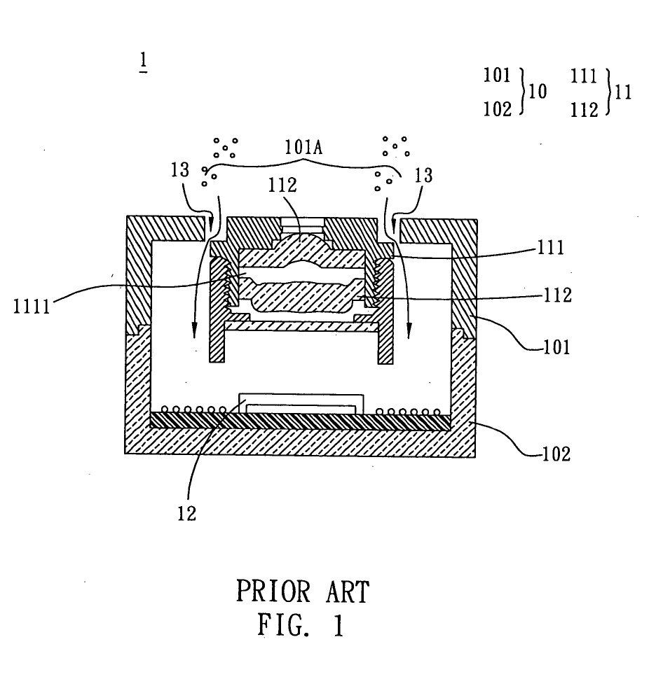

FIG. 2 is a schematic sectional view showing an image capture module according to a preferred embodiment of the invention;

FIG. 3 is a schematic exploded view showing an image capture module according to the preferred embodiment of the invention; and

FIG. 4 is a schematic sectional view showing an electronic device according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

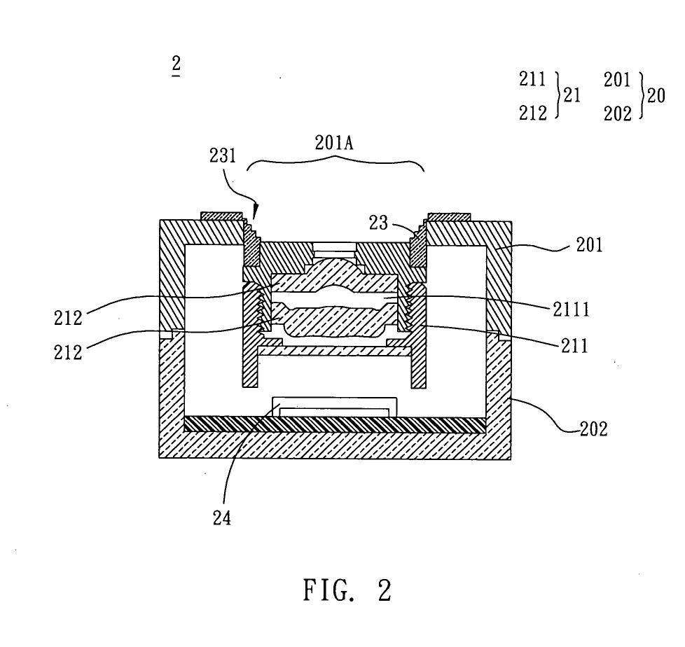

With reference to FIG. 2, an image capture module 2 according to a preferred embodiment of the invention includes a housing 20, a camera unit 21, and an elastic element 23. In the present embodiment, the elastic element 23 is as a shielding element disposing between the camera unit 21 and the housing 20.

As shown in FIG. 2, the hosing 20 includes a front cover 201 and a rear cover 202. The front cover 201 and the rear cover 202 are connected with each other to form the housing 20. The housing 20 has a first opening 201A, which is formed on the front cover 201 of the housing 20. The camera unit 21 is accommodated in the housing 20 and is adjacent to the first opening 201A. The first opening 201A exposes at least one portion of the camera unit 21.

As mentioned above, the camera unit 21 includes a barrel 211 and a lens assembly 212. The barrel 211 includes a container 2111 where the lens assembly 212 is accommodated. Herein, the lens assembly 212 has a plurality of lenses.

The elastic element 23 is disposed between the camera unit 21 and housing 20. One portion of the elastic element 23 is connected to the housing 20 and the other portion of the elastic element 23 surrounds the camera unit 21. With reference to FIG. 2, the front cover 201 of the housing 20 is connected with the camera unit 21 through the elastic element 23 such that the elastic element 23 and the camera unit 21 simultaneously cover the first opening 201A. Therefore, the hosing 20 and the camera unit 21 are tightly connected and have no space between them, so that the foreign particles are prohibited from entering into the image capture module 2.

In the present embodiment, the elastic element 23 can be made of an elastic material such as rubber or plastic. The image capture module 2 does auto-focus process and the camera unit 21 moves corresponding to the first opening 201A. The elastic element 23 is compressed when the camera unit 21 is close to the first opening 201A and the elastic element 23 is restored when the camera unit 21 is away from the first opening 201A. In such manner, the elastic element 23 is provided for absorbing shock generated in the movement of the camera unit 21. Moreover, in the present embodiment, a surface 231 of the elastic element 23, on which the light beam is incident, has a rough structure such as a ladder structure (as shown in FIG. 2) or a waved structure. The rough structure can be integrately formed on the elastic element 23. Therefore, the useless light for the image generation can be effectively reflected and absorbed by the aforesaid rough structure, and the opportunity for the useless light entering into the camera unit 21 can be reduced. Additionally, the elastic element 23 can be doped with mental particles for impeding the interference of the electromagnetic wave.

The image capture module 2 of the present embodiment further can include a sensor 24 accommodated in the housing 20 and disposed between the camera unit 21 and the housing 20. The sensor 24 is used to receive a light beam passing through the first opening 201A and the camera unit 21 orderly and then generate an image. In the present embodiment, the sensor 24 can be a charge coupled device (CCD) or a complementary metal oxide semiconductor sensor (CMOS).

Additionally, the image capture module 2 of the present embodiment further includes a transmission element (not shown in the figure), which drives the camera unit 21 close to or away from the first opening 201A. That is, when the image capture module 2 progresses auto-focus process, the camera unit 21 is driven by the transmission element to move corresponding to the first opening 201A.

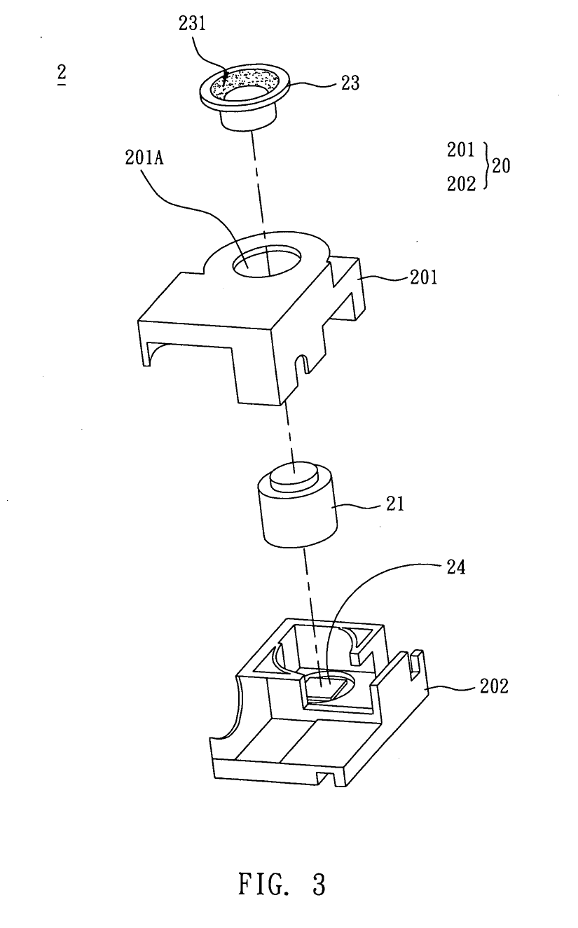

With reference to FIG. 3 for fully understand the content of the invention, it is a schematic exploded view of showing the image capture module 2 according to the preferred embodiment of the invention. The sensor 24 is accommodated in the rear cover 202 of the housing 20. The camera unit 21 is corresponding disposed with sensor 24. At least one portion of the camera unit 21 is accommodated in the rear cover 202. The front cover 201 is connected with the rear cover 202 to completely contain the camera unit 21 into the housing 20. The front cover 201 has the first opening 201A disposed opposite to the camera unit 21. The light beam passes through the first opening 201A and the camera unit 21 and finally arrives at the sensor 24 to generate an image. The elastic element 23 is disposed between the front cover 201 and the camera unit 21 so that there is no space between the housing 20 and the camera unit 21 and the foreign particle is effectively prohibited from entering into the image capture module 2. Moreover, the surface 231 of the elastic element 23 on which the light beam is incident has the rough structure to effectively reflect or absorb useless light from the outside.

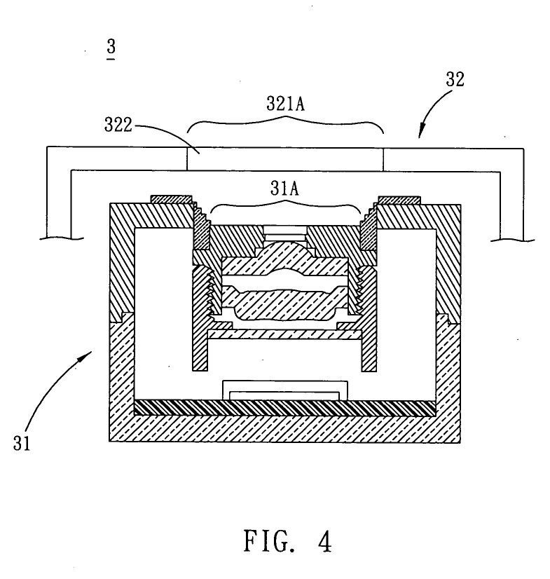

In addition, with reference to FIG. 4, an electronic device 3 according to a preferred embodiment of the invention includes an image capture module 31 and a main body 32.

Due to the structure, disposition, and function of the image capture module 31 are the same as those mentioned above, so the detailed description are omitted herein.

The main body 32 has a second opening 321A and a transparent cover 322. The image capture module 31 is disposed in the main body 32. The second opening 321A is corresponding disposed with the first opening 31A. The transparent cover 322 covers the second opening 321. In the present embodiment, the electronic device 3 can be a mobile phone and the main body 32 can be the housing of the mobile phone. Certainly, the electronic device 3 also can be else electronic products having image capture function.

In conclusion, the electronic device and the image capture module thereof of the invention are by way of disposing a shielding element between the camera unit and the housing. Specially, the shielding element is disposed around the camera unit such that the first opening of the housing is covered by the shielding element and the camera unit. Due to no space between the housing and the camera unit, the purpose of prohibiting the foreign particles from entering into the image capture module is achieved. Moreover, the shielding element can be elastic for absorbing the shock generated in the movement of the camera unit corresponding to the first opening. Therefore, the image capture module of the invention further has a shock absorbing ability. In addition, the surface of the shielding element can be designed for having a rough structure, such as a waved structure or a ladder structure. The rough structure is used to absorb or reflect the useless light beams for image generation so as to improve the quality of the image. Furthermore, the shielding element can be doped with mental particles to reduce interference of the electromagnetic wave.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An image capture module, comprising:
a housing, which has a first opening;
a camera unit, which is accommodated in the housing and is adjacent to the first opening, wherein the first opening exposes at least one portion of the camera unit; and
a shielding element, which is disposed between the camera unit and the housing, wherein the shielding element is disposed around the camera unit such that the shielding element and the camera unit cover the first opening.

2. The image capture module of claim 1, wherein the camera unit comprises a barrel and a lens assembly, the barrel comprises a container where the lens assembly is accommodated.

3. The image capture module of claim 1, wherein the surface of the shielding element has a rough structure.

4. The image capture module of claim 1, wherein the surface of the shielding element has a ladder structure.

5. The image capture module of claim 1, wherein the surface of the shielding element has a waved structure.

6. The image capture module of claim 1, wherein the shielding element is an elastic element.

7. The image capture module of claim 6, wherein the elastic element is made of rubber or plastic.

8. The image capture module of claim 1, wherein the shielding element is doped with mental particles.

9. The image capture module of claim 1, further comprising:
a sensor, which is accommodated in the housing and is used to receive a light beam passing through the camera unit.

10. The image capture module of claim 1, further comprising:
a transmission element, which drives the camera unit close to or away from the first opening.

11. An electronic device, comprising:
an image capture module, which comprises a housing, a camera unit, and a shielding element, the housing has a first opening, the camera unit is accommodated in the housing and is adjacent to the first opening, the first opening exposes at least one portion of the camera unit, and the shielding element is disposed between the camera unit and the housing, wherein the shielding element is disposed around the camera unit such that the shielding element and the camera unit cover the first opening; and
a main body, which the image capture module is accommodated in, wherein the main body has a second opening and a transparent cover, the second opening is correspondingly disposed with the first opening, and the transparent cover covers the second opening.

12. The electronic device of claim 11, wherein the camera unit comprises a barrel and a lens assembly, the barrel comprises a container where the lens assembly is accommodated.

13. The electronic device of claim 11, wherein the surface of the shielding element has a rough structure.

14. The electronic device of claim 11, wherein the surface of the shielding element has a ladder structure.

15. The electronic device of claim 11, wherein the surface of the shielding element has a waved structure.

16. The electronic device of claim 11, wherein the shielding element is an elastic element.

17. The electronic device of claim 16, wherein the elastic element is made of rubber or plastic.

18. The electronic device of claim 11, wherein the shielding element is doped with mental particles.

19. The electronic device of claim 11, further comprising:
a sensor, which is accommodated in the housing and is used to receive a light beam passing through the camera unit.

20. The electronic device of claim 11, further comprising:
a transmission element, which drives the camera unit close to or away from the first opening.

21. The electronic device of claim 11, wherein the electronic device is a mobile phone.
